(19) United States
(12) Patent Application Publication
(10) Pub. No.: US 2009/0114095 A1
(43) Pub. Date: May 7, 2009

(54) FILTER CLEANING SYSTEM AND METHOD

(75) Inventors: Ryan A. Hanson, Olathe, KS (US); Larry D. McConnnell, Lee's Summit, MO (US); Paul S. Henry, Lee's Summit, MO (US); Marc H. Moreano, Kansas City, MO (US); Stacy P. Moreano, Kansas City, MO (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/935,761

(22) Filed: Nov. 6, 2007

(51) Int. Cl. B01D 53/02

(52) U.S. Cl. 95/148; 96/142

(57) ABSTRACT

A filter cleaning system according to one aspect of the invention comprises a baghouse including a tubesheet having a plurality of openings extending therethrough. A plurality of filter cartridges is sealingly mounted to the tubesheet at respective openings. Each filter cartridge has an open end and pleated media for filtering particulates from gas flowing therethrough. The filter cartridge has particulates accumulate on the pleated media. A pulse cleaning system intermittently directs cleaning pulses of air into the open ends of the filter cartridges media at a supply pressure in the range of about 20 PSI to 60 PSI to dislodge accumulated particulates from the pleated media.

### BACKGROUND

The invention relates generally to a system and method for cleaning filters in a baghouse. In particular, the invention relates to cleaning filter cartridges with “medium pressure” reverse air pulses.

Filters for removing particulates from a particulate-laden gas stream flowing through a baghouse are known. The particulates are typically generated by an industrial process and carried to the filters in the gas flow stream. The filters include media that is formed into filter cartridges or filter bags. The particulate-laden gas flows through the filters from outside towards inside. The particulates are separated from the gas stream at the outer side of the filters. The filtered gas stream flows through the media and exits the filter through an open end. The filtered gas stream then is conducted to subsequent plant uses or the atmosphere.

Over time, a buildup of accumulated particulates form on the outer sides of the filters and becomes thicker and thicker. This increasing buildup of particulates causes an increase in pressure drop across the filters. This increased pressure drop is costly because more power is consumed to generate an effective flow of gas through the filters.

The filters are periodically cleaned to remove the particulate buildup and reduce the pressure drop across the filters. To clean the filters, air is blown into the open end of the filters to dislodge the particulate buildup adhering to their outer sides. Known cleaning systems typically provide a pulse of compressed air into the filters at a supplied pressure in the range of about 70 to 100 PSI.

The pulses of compressed air tend to put mechanical stresses on the filter that approach the limit the media can repeatedly withstand. Such stresses can affect the service life of the filter. Replacing the filters in a baghouse can be costly and result in operational downtime.

One cleaning system, disclosed in U.S. Patent Application Publication 2004/0261375, supplies pulses of air into the filters at relatively low pressure. The supply pressure is in the range of about 7 PSI to 52 PSI. However, this cleaning system design requires that the baghouse be closed off from operational filtering in order for this low cleaning pressure to be effective. A portion of the baghouse undergoing cleaning is kept offline for a period of time after the duration of the cleaning pulse to permit the dislodged particulates to fall to the bottom of the baghouse. The portion of the baghouse being offline has an economic disadvantage because it limits filtering throughput or requires additional capacity to permit a given throughput of gas flow.

### BRIEF DESCRIPTION

An effective and reliable system and method for cleaning filters in a baghouse is provided according to one aspect of the invention. The cleaning system of the invention is capable of operating at a relatively low pressure during a filtering operation of the baghouse. Thus, the cleaning system of the present invention has advantages over previously known systems because it does not require a filtering operation to have any portion out of service during a cleaning cycle. The cleaning system of the present invention reduces the stress placed on a filter when exposed to a cleaning pulse. This reduced stress could potentially increase filter service life.

A filter cleaning system according to one aspect of the invention includes a baghouse. The baghouse includes a tubesheet with a plurality of openings extending therethrough. A plurality of filter cartridges is sealingly mounted to the tubesheet at respective openings. Each filter cartridge has an open end and pleated media for filtering particulates from gas flowing therethrough. The filter cartridge has particulates accumulate on the pleated media. A pulse cleaning system intermittently directs cleaning pulses into the open ends of the filter cartridges at a supply pressure in the range of about 20 PSI to 60 PSI to dislodge accumulated particulates from the pleated media.

A filter cleaning system according to one aspect of the invention includes a baghouse. The baghouse includes a tubesheet with a plurality of openings extending therethrough. A plurality of filter cartridges is sealingly mounted to the tubesheet at respective openings. Each filter cartridge has an open end and pleated media for filtering particulates from gas continuously flowing therethrough during filtering operation of the baghouse. The filter cartridge has particulates accumulate on the pleated media. A pulse cleaning system intermitently directs cleaning pulses of gas into the open end of the filter cartridges during filtering operation of the baghouse at a supply pressure in the range of about 20 PSI to 60 PSI to dislodge accumulated particulates from the pleated media.

A method of cleaning a filter comprises the steps of providing a baghouse with a tubesheet that has a plurality of openings extending through the tubesheet. A plurality of filter cartridges are provided and mounted to the tubesheet at respective openings. Each of the filter cartridges has an open end and pleated media. Particulates are filtered from gas continuously flowing in a first direction through the plurality of filter cartridges. The particulates accumulate on the pleated media. Intermittent cleaning pulses are directed in a second direction opposite to the first direction of gas flow into open ends of the filter cartridges during the filtering step at a supply pressure in the range of about 20 PSI to 60 PSI to dislodge accumulated particulates from the pleated media.

### DRAWINGS

These and other features, aspects, and advantages of the invention will be better understood when the following detailed description is read with reference to the accompanying drawings, in which:

FIG. 1 is a schematic representation of a baghouse and cleaning system according to one aspect of the invention;

FIG. 2 is an enlarged view of a portion of the baghouse and cleaning system illustrated in FIG. 1;

FIG. 3 is an enlarged view of another portion of the cleaning system illustrated in FIG. 1, taken approximately along the line 3-3 in FIG. 1; and

FIG. 4 is a view of the cleaning system illustrated in FIG. 3, taken approximately along line 4-4 of FIG. 3.

### DETAILED DESCRIPTION

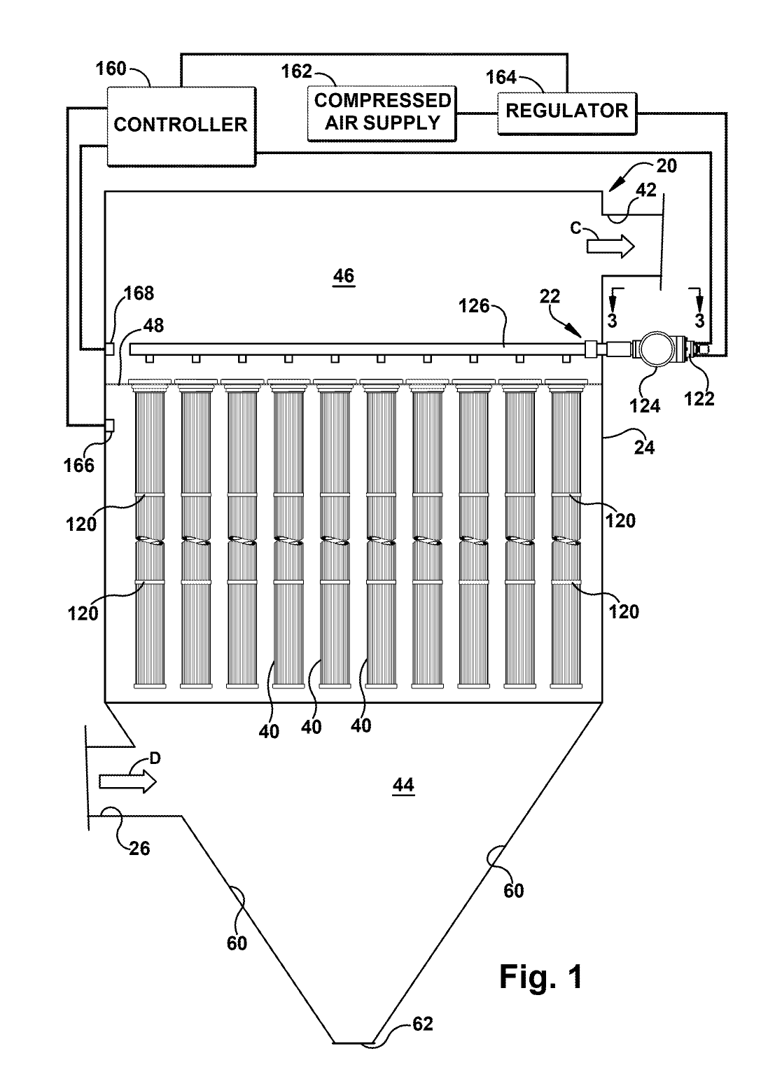

A baghouse 20 incorporating a reverse pulse filter cleaning system 22, constructed according to one aspect of the invention, is illustrated in FIG. 1. The baghouse 20 is defined by an enclosed housing 24. The housing 24 is made from a suitable material, such as sheet metal. Particulate-laden gas D flows into the baghouse 20 from an inlet 26. The particulate-laden gas D is filtered by a plurality of relatively long filter cartridges 40 located within the baghouse 20. Filtered or clean gas C exits through an outlet 42 of the baghouse 20.

The baghouse 20 is divided into a “dirty gas” plenum 44 and a “clean gas plenum 46 by a tubesheet 48 made from a suitable material, such as sheet metal. The inlet 26 is in fluid communication with the dirty gas plenum 44. The outlet 42 is in fluid communication with the clean gas plenum 46.

The baghouse 20 also has an accumulation chamber defined by sloped walls 60 located at a lower end of the dirty gas plenum 44. The accumulation chamber receives and temporarily stores particulates and other debris that are separated from the particulate-laden gas D or fall off of the filter cartridges 40. The stored particulates and debris exit the accumulation chamber through an opening 62.

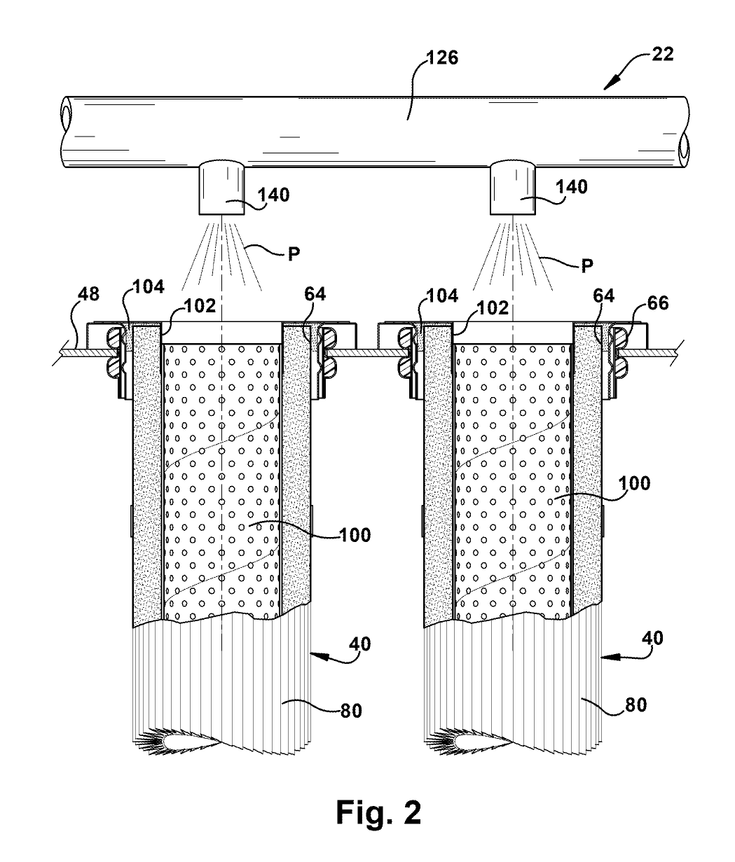

A plurality of openings 64 (FIG. 2) extends the tubesheet 48. A filter cartridge 40 is installed in a respective opening 64. Each of the filter cartridges 40 is mounted within the respective opening 64 so it seals against the tubesheet 48 and isolates the dirty gas plenum 44 from the clean gas plenum 46. While the filter cartridges 40 are illustrated as being mounted to extend in a substantially vertical direction, the filter cartridges could be mounted to extend in any direction, for example horizontally or at an angle.

By way of example and not limitation, a circumferential resilient mounting band 66 is located in each one of the openings 64 in the tubesheet 48. The band 66 is made from metal, such as a stainless steel, and is covered with fabric. The band 66 is constructed with an outer diameter substantially equal to the inner diameter of the opening 64. The band 66 may be easily deformed from its normally circumferential shape and inserted into the opening 64. The exterior surface of the band 66 snugly engages the surface defining the opening 64. The band 66 provides the seal between the filter cartridge 40 and the opening 64 in the tubesheet 48. Any suitable mounting structure may be used to attach, support and seal the filter cartridges 40 to the tubesheet 48.

The filter cartridges 40 filter particulates from the particulate-laden gas D as the gas passes through each filter cartridge. Each filter cartridge 40 includes pleated filter media 80. The filter media 80 is formed into a tubular configuration with a circular cross-section. It will be apparent that the filter cartridge 40 may be any desired length in order to meet the filtering requirements of the baghouse 20.

The pleated filter media 80 is located concentrically around a support member 100 of the filter cartridge 40. The pleated filter media 80 is located about the perimeter of the support member 100 and has accordion folds at its inner and outer peripheries. The pleated filter media 80 has an effective filtering length or axial extent that is dependant on the requirements of the design of the baghouse 20. The pleated filter media 80 may be constructed of any suitable material for desired filtering requirements and operating conditions. For example, materials such as polyester, acrylic and polypropylene are generally acceptable for operating temperatures in the range of 180° F. to 225° F. Aramid and PPS are suitable for up to 375° F. Fiberglass is suitable for use up to 450° F.

The support member 100 may be made of any suitable material for its intended use, such as plastic or metal. The support member 100 supports the pleated filter media 80 in a radial inward direction during gas flow through the filter cartridge 40 during filtering operation of the baghouse 20. The upper end of the pleated filter media 80 is located in a mounting sleeve 102 and secured in a potting material 104, which also serves to seal the pleated filter media and the mounting sleeve.

The filter cartridges 40 are illustrated as having retention devices 120 (FIG. 1) extending circumferentially about the pleated filter media 80. The retention devices 120 serve to hold the pleated filter media 80 in place during reverse pulse cleaning of the filter cartridges 40. Specifically, the retention devices 120 limit movement of the pleated filter media 80 in a radial outward direction during reverse pulse cleaning. The retention devices 120 may be in the form of a strap or an extruded elastomer.

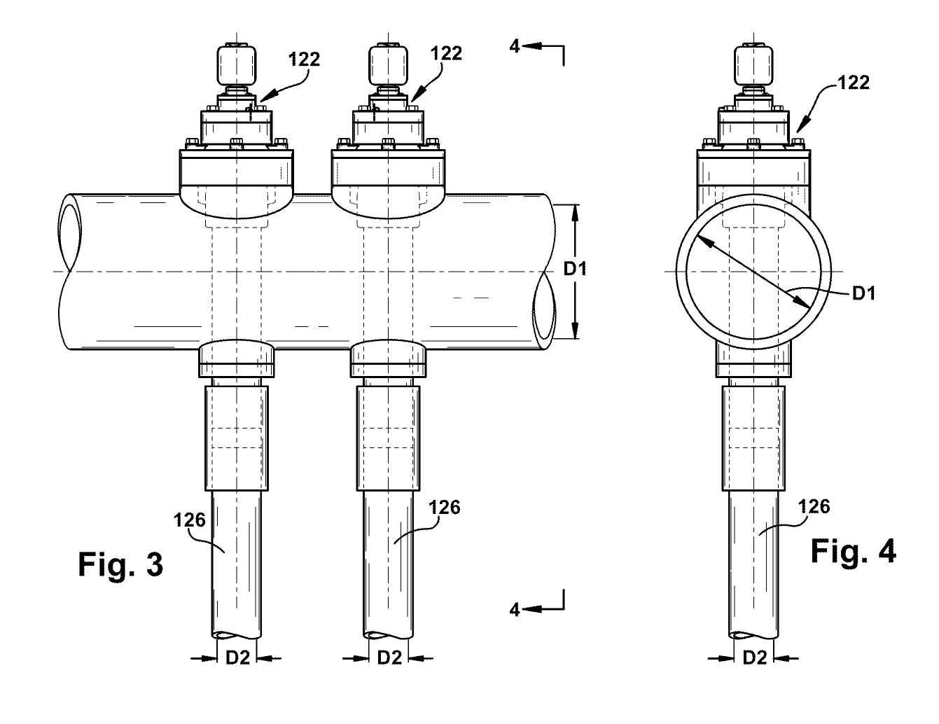

The reverse pulse cleaning system 22 according to one aspect of the invention includes a plurality of pulse valves 122 (FIGS. 3 and 4). Each pulse valve 122 is fluidly connected to a compressed air manifold or header 124 that supplies compressed fluid, such as air. Each of the pulse valves 122 is arranged to direct compressed air stored in the header 124 through a respective one of a plurality of blowpipes 126. Each of the blowpipes 126 has a plurality of nozzles 140. Periodically, the pulse valves 122 are operated to allow a pulse P of compressed air to flow from the manifold 124, to the blowpipes 126, through the nozzles 140 and into the filter cartridges 40 while filtering operation of the baghouse 20 continues. The baghouse 20 does not have to be shut down during this cleaning operation so it does not go off-line.

The nozzles 140 are positioned a predetermined distance from the tubesheet 24 and located along the longitudinal central axis of a respective filter cartridge 40, as illustrated in FIG. 2. The nozzle 140 being tubular is by way of example only and not limitation. It will be apparent that any type or design of nozzle 140 may be used. It will also be apparent that nozzles could be eliminated entirely and openings could be formed in the blowpipe 126 for directing the cleaning pulses P into the filter cartridges 40.

The header 124 has an inner diameter D1 in the range of about 8 inches to 16 inches, and preferably in the range of about 10 inches to 14 inches. Each of the blowpipes 126 has an inner diameter D2 in the range of about 1 inch to 4 inches, and preferably in the range of about 2.5 inches to 4 inches. The header 124 and blowpipes are relatively larger than what is found in known high pressure systems. This sizing assures that an adequate volume of cleaning air is delivered at a relatively lower pressure to the filter cartridges 40. The valves 122 are appropriately sized to the diameters of the header 124 and blowpipes 126.

The blowpipe 126 is supported by the housing 24. The nozzle 140 of the reverse pulse cleaning system 22 is permanently attached to the blowpipe 126, such as by welding. In the illustrated embodiment, the nozzle 140 is a fabricated from a metal tubular member and has a substantially constant circular cross-section extending along its length in a direction parallel to its longitudinal central axis. The nozzle 140 defines a passage for the cleaning air delivered from the blowpipe 126.

After a period of filtering operation of the baghouse 20, a pressure drop across each of the filter cartridges 40 will increase due to the accumulation of particulates separated from the particulate-laden gas flow D and accumulate at the outer surfaces of the pleated filter media 80. The filter cartridges 40 are periodically cleaned by directing pulses P (FIG. 2) of a cleaning gas, such as compressed air, into the open end of each of the filter cartridges. This cleaning is referred to as reverse pulse cleaning.

The reverse cleaning pulse P is directed into each filter cartridge 40, in a diverging pattern along a longitudinal central axis of the filter cartridge. The reverse cleaning pulse P flows from the inside of the filter cartridge 40 through the pleated filter media 80 to the outside of the filter cartridge in a “reverse” or opposite direction to normal filtering gas flow. This cleaning pulse P will remove at least some, and preferably a significant amount, of the particulates accumulated at the outer surface of the filter cartridge 40 and reduce the pressure drop across the filter cartridge.

The reverse pulse cleaning system 22 also includes a controller 160 (FIG. 1), a compressed air supply 162 and a regulator 164. The controller 160 has a pair of sensors 166, 168 associated with it for determining the pressure differential or drop across the filter cartridges 40. Sensor 166 is located in the dirty gas plenum 44. Sensor 168 is located in the clean gas plenum 46. The pressure differential or drop across the filter cartridges 40 is the pressure sensed by sensor 166 in the dirty gas plenum 44 minus the pressure sensed by sensor 168 in the clean gas plenum 46.

Referring to FIG. 1, the reverse pulse cleaning system 22 according to one aspect of the invention is illustrated. The reverse cleaning pulse P is provided by the cleaning system 22. Directing a cleaning pulse P of compressed air is done periodically into each filter cartridge 40 through its open end. By “periodic”, it is meant that a controller 160 of the reverse pulse cleaning system 22 can be programmed or the system can be manually operated such that at selected times there will be a cleaning pulse P of compressed air directed into the filter cartridge 40. For example, the selected time could be after a predetermined duration or after a certain amount of pressure drop across the filter cartridges 40 is detected.

In general, the reverse pulse cleaning system 22 delivers a sufficient flow of “medium” pressure fluid as the cleaning pulses P of compressed air to clean the filter cartridges 40. By “pulse”, it is meant a flow of a sufficient volume of gas at a pressure sufficient to overcome the filtering operation flow of particulate-laden gas D in the dirty gas plenum 44 for a limited time duration. The limited time duration may be in the range of about 0.1 second to 0.35 second. The pressure of the cleaning gas delivered by the air supply 162 and regulated by the regulator 164 to the header 124 to generate the cleaning pulse P is in the range of about 20 PSI to 60 PSI, and preferably in the range of about 30 PSI to 50 PSI.

The volume flow from each of the nozzles 140 at this “medium” pressure is sufficient to overcome the operational filtering flow through the respective filter cartridge 40 and to dislodge or remove any accumulated particulates and debris from the outer surface of the pleated media 80. It is important to realize that the reverse cleaning pulse P is delivered while the baghouse 20 is allowing filtering operation. The cleaning pulse P locally overcomes the filter gas flow through the filter cartridges 40. Cleaning is done in rows of filter cartridges 40.

The cleaning pulse P emerging from the nozzle 140 creates a pressure wave along the longitudinal extent of the filter cartridges 40. Due to the suddenly occurring pressure change and the reversal of the flow direction, the pleated media 80 and accumulated particulate buildup are forced radially outward. The accumulated particulate buildup is separated from the outer surfaces of the pleated media 80. The separated accumulated particulate buildup drops into the accumulation chamber defined by the walls 60 and exits the baghouse 20 through the opening 62. The particulates can then be carried away from the baghouse 20, for instance, by means of a screw conveyor (not shown). Being subject to relatively less stress applied by the “medium” pressure of the cleaning pulses P, the service life of the filter cartridges 40 can be increased and relatively lower cost associated with delivering the cleaning air is expected.

Typically several rows of filter cartridges 40 are arranged within the baghouse 20. Each row of filter cartridges 40 is subjected to the cleaning pulses P separately from a single blowpipe 126. This arrangement has the advantage of minimizing the size, demands for energy and volume cleaning air placed on the air supply 162.

In continuous filtering operation of the “medium pressure” baghouse 20, particulate-laden gas D enters the baghouse through inlet 26 at a temperature that can reach about 450° F. or higher. The particulate-laden gas D flows upwardly and into the filter cartridges 40. Particulates separate from the gas as it passes through the pleated media 80. The cleaned gas C then flows through the open ends at the top of the filter cartridges 40 and through the outlet 42 of the baghouse 20.

Throughout the continuous filtering operation of the baghouse 20, separated particulates accumulate at the outer surface of the pleated media 80. Over time, as more and more particulates accumulate on the pleated media 80, the pressure drop across the filter cartridges 40 increases. This typically increases the power consumption needed for fans (not shown) to move gas through the baghouse 20.

Sensors 166 and 168 continually monitor the pressure in each of the plenums 44 and 46, respectively. These pressures are communicated to the controller 160. The controller 160 can be any suitable device, such as a personal computer or PLC. The controller 160 determines the pressure drop across the filter cartridges 40 based on information from the sensors 166, 168. When the pressure drop increases to a value greater than a predetermined maximum desired threshold value, the controller 160 sends a signal to one of the valves 122 to open and generate a cleaning pulse P. The cleaning operation continues by the controller 160 sequentially opening valves 122 until the pressure drop decreases to below a predetermined minimum threshold value, at which time the cleaning operation stops.

The regulator 164 has established a supply of air at a predetermined pressure in the range of about 20 PSI to 60 PSI from the air supply 162 to the headers 124 behind or upstream of the valves 122. When a valve 122 opens, this air supply flows into the blowpipe 126 associated with that valve and a cleaning pulse P flows from the nozzles 140 into the inside of the filter cartridges 40. The cleaning pulse P dislodges accumulated particulates from the outer surfaces of the pleated media 80 in a row of filter cartridges 40. All this cleaning is done while the baghouse 20 is continuously operating to filter the particulate-laden gas D. Each row of filter cartridges 40 is sequentially cleaned in this manner until all of the rows have been serviced. The particulates dislodged from the pleated media 80 fall to the bottom of the baghouse 20 and the pressure drop is reduced across that row of filter cartridges 40 with minimal stress to the filter cartridges.

Although the systems herein have been disclosed in the context of certain preferred embodiments and examples, it will be understood by those skilled in the art that the invention extends beyond the specifically disclosed embodiments to other alternative embodiments and/or uses of the systems and techniques herein and obvious modifications and equivalents thereof. Thus, it is intended that the scope of the invention disclosed should not be limited by the particular disclosed embodiments described above, but should be determined only by a fair reading of the claims that follow.

Having described at least one aspect of the invention, what is claimed is:

1. A filter cleaning system comprising:
a baghouse including a tubesheet having a plurality of openings extending there through;
a plurality of filter cartridges sealingly mounted to the tubesheet at respective openings, each filter cartridge having an open end and pleated media for filtering particulates from gas flowing therethrough, and the filter cartridge having particulates accumulate on the pleated media;
a pulse cleaning system for intermitently directing cleaning pulses of gas into the open ends of respective filter cartridges at a supply pressure in the range of about 20 PSI to 60 PSI to dislodge accumulated particulates from the pleated media.

2. The filter cleaning system of claim 1 wherein the cleaning pulses of gas have a duration of less than about 0.35 second.

3. The filter cleaning system of claim 1 wherein each cleaning pulse is provided at a supply pressure in the range of about 30 PSI to 50 PSI.

4. The filter cleaning system of claim 1 wherein the filter cartridges are exposed to gas continuously flowing therethrough at a temperature up to about 450° F.

5. The filter cleaning system of claim 1 wherein the pulse cleaning system comprises a header, a valve and a blowpipe with a nozzle, in which the header, valve, blowpipe and nozzle are selected to provide a cleaning pulse into a filter cartridge at a supply pressure in the range of about 20 PSI to 60 PSI

6. A filter cleaning system comprising:
a baghouse including a tubesheet having a plurality of openings extending therethrough;
a plurality of filter cartridges sealingly mounted to the tubesheet at respective openings, each filter cartridge having an open end and pleated media for filtering particulates from gas continuously flowing therethrough during a filtering operation of the baghouse, and the filter cartridge having particulates accumulate on the pleated media; and
a pulse cleaning system for intermitently directing cleaning pulses of gas into the open end of the filter cartridges during filtering operation of the baghouse at a supply pressure in the range of about 20 PSI to 60 PSI to dislodge accumulated particulates from the pleated media.

7. The filter cleaning system of claim 6 wherein the cleaning pulses of gas have a duration of less than about 0.35 second.

8. The filter cleaning system of claim 6 wherein each cleaning pulse is provided at a supply pressure in the range of about 30 PSI to 50 PSI.

9. The filter cleaning system of claim 6 wherein the pulse cleaning system comprises a header and a blowpipe with a nozzle to provide a gas cleaning pulse into the filter cartridge.

10. The filter cleaning system of claim 6 wherein the filter cartridge is exposed to gas continuously flowing therethrough at a temperature up to about 450° F.

11. A method of cleaning a filter, the method comprising the steps of:
providing a baghouse with a tubesheet that has a plurality of openings extending through the tubesheet;
providing a plurality of filter cartridges mounted to the tubesheet at respective openings, each of the filter cartridges has an open end and pleated media;
filtering particulates from gas continuously flowing in a first direction through the plurality of filter cartridges, which particulates accumulate on the pleated media; and
directing intermittent cleaning pulses in a second direction opposite to the first direction of gas flow into open ends of the filter cartridges during the filtering step at a supply pressure in the range of about 20 PSI to 60 PSI to dislodge accumulated particulates from the pleated media.

12. The method of claim 11 wherein the directing step includes providing a pulse cleaning system comprising a header, a valve and a blowpipe with a nozzle in which the header, valve, blowpipe and nozzle provide a cleaning pulse into an open end of a respective one of the filter cartridges.

13. The method of claim 11 wherein the cleaning pulses of gas in the directing step have a duration of less than about 0.35 second.

14. The method of claim 11 wherein each cleaning pulse of gas in the directing step is provided at a supply pressure in the range of about 30 PSI to 50 PSI.

15. The method of claim 11 wherein during the filtering step the filter cartridges are exposed to gas continuously flowing therethrough at a temperature up to about 450° F.
